(19) United States
(12) Patent Application Publication
(10) Pub. No.: US 2022/0033217 A1
(43) Pub. Date: Feb. 3, 2022

(54) MULTI-CAR ELEVATOR SYSTEM WITH AUTONOMOUS CAR MOVERS CONFIGURED FOR COLLISION AVOIDANCE

(71) Applicant: Otis Elevator Company, Farmington, CT (US)

(72) Inventors: Randy Roberts, Hebron, CT (US); Sam Thieu Wong, Bridgeport, CT (US); Vincent Refuerzo Ybanez, West Haven, CT (US)

(21) Appl. No.: 16/943,007

(22) Filed: Jul. 30, 2020

(51) Int. Cl. B66B 5/00; B66B 1/34; B66B 1/28

(52) U.S. Cl. CPC B66B 5/0031; B66B 1/28; B66B 1/3446

(57) ABSTRACT

Disclosed is ropeless elevator system having: a car mover operationally connected to an elevator car, the car mover configured to move the elevator car along a hoistway lane and to operate autonomously, wherein the car mover has an Autonomous Car Separation Assurance (ACSA) system that has: a sensor configured to provide sensor data representing positional information of the elevator car, a motion control system configured to control motion of the car mover, wherein the ACSA system is configured to estimate an operational state of the elevator car by processing the sensor data and velocity data, representing velocity of the car mover within the hoistway lane, via a State Observe Filter, and wherein the ACSA system is configured to control the car mover to avoid a collision between the elevator car and another object in response to estimating the operational state of the elevator car.

### BACKGROUND

Embodiments described herein relate to a multi-car elevator system and more specifically to a multi-car elevator system with autonomous car movers configured for collision avoidance.

Self propelled elevator cars may lack physical connections between the hoistway and the elevator car (e.g., no traveling cable, governor rope, etc.). Multiple cars in one hoistway may be supported by self propelled elevator car systems (with or without physical connections). Collision avoidance (ensuring distancing between cars) is a goal for instillations with multiple cars in one hoistway. This may be of particular relevance with a fully autonomous system, where all controls are on the elevator car itself, as compared with known multi-car system where all cars are controlled by a central controller for a hoistway lane. That is, in systems where cars are autonomous relative to each other and a central controller, there is a need to need to ensure collisions are avoided on a local level.

### BRIEF SUMMARY

Disclosed is ropeless elevator system including: a car mover operationally connected to an elevator car, the car mover configured to move the elevator car along a hoistway lane and to operate autonomously, wherein the car mover includes an Autonomous Car Separation Assurance (ACSA) system that includes: a sensor configured to provide sensor data representing positional information of the elevator car, a motion control system configured to control motion of the car mover, wherein the ACSA system is configured to estimate an operational state of the elevator car by processing the sensor data and velocity data, representing velocity of the car mover within the hoistway lane, via a State Observe Filter, and wherein the ACSA system is configured to control the car mover to avoid a collision between the elevator car and another object in response to estimating the operational state of the elevator car.

In addition to one or more of the above disclosed aspects of the system or as an alternate the ACSA system includes a controller that controls the car mover, the controller operationally connected to the sensor and configured to control movement of the car mover, wherein one or more of the sensor, the controller and a cloud service is configured to at least in part process the sensor data and/or estimate the operational state of the elevator car.

In addition to one or more of the above disclosed aspects of the system or as an alternate the sensor communicates with a controller of the ACSA system directly, via a personal or local area network, or via a cloud service.

In addition to one or more of the above disclosed aspects of the system or as an alternate the ACSA system is configured to control the car mover to avoid a collision between the elevator car and a hoistway terminus in response to estimating the operational state of the elevator car.

In addition to one or more of the above disclosed aspects of the system or as an alternate the ACSA system is configured to control the car mover and/or the elevator car to execute an emergency stop in response to estimating the operational state of the elevator car.

In addition to one or more of the above disclosed aspects of the system or as an alternate the State Observe Filter includes a Recursive Kalman Filter Estimator.

In addition to one or more of the above disclosed aspects of the system or as an alternate the sensor is configured for sensing one or more of elevator car position, velocity, a forward range and a backward range.

In addition to one or more of the above disclosed aspects of the system or as an alternate the sensor includes one or more of a camera, radar, and LiDAR for sensing one or more of a forward range and a backward range.

In addition to one or more of the above disclosed aspects of the system or as an alternate the sensor is configured to sense one or more of a forward range and a backward range via ultrasonic distancing, laser distancing, magnetic detection, non-sacrificial physical compression/deflection detection, and sacrificial physical compression/deflection detection.

In addition to one or more of the above disclosed aspects of the system or as an alternate the ropeless elevator system is a multi-car ropeless system, and the car mover is configured to operate autonomously relative to an adjacent car mover that moves an adjacent elevator car in the hoistway lane.

In addition to one or more of the above disclosed aspects of the system or as an alternate the ACSA system is configured to control the elevator car to avoid a collision between the elevator car and an adjacent elevator car moving in the hoistway lane in response to estimating the operational state of the elevator car.

In addition to one or more of the above disclosed aspects of the system or as an alternate the ACSA system is configured to transmit a signal to an adjacent car or adjacent car mover in the hoistway lane, via one or more transmission paths, upon determining a likelihood of a collision is above a threshold.

In addition to one or more of the above disclosed aspects of the system or as an alternate the ACSA system is configured to transmit a stop command as the signal to the adjacent car or adjacent car mover in the hoistway lane, via the one or more transmission paths, upon determining the likelihood of the collision is above the threshold.

In addition to one or more of the above disclosed aspects of the system or as an alternate the ACSA system is configured to communicate with the adjacent car mover over a wireless connection via one or more of a personal area network, a local area network and a cloud service.

In addition to one or more of the above disclosed aspects of the system or as an alternate the ACSA system is configured to transmit periodic test signals to the adjacent car mover and monitor for periodic test signals transmitted from the adjacent car mover to track transmission reliability.

Further disclosed is method of operating a ropeless elevator system, including: a sensor, of an Autonomous Car Separation Assurance (ACSA) system of a car mover that moves an elevator car along a hoistway lane, providing sensor data representing positional information for the elevator car; the ACSA system estimating an operational state of the elevator car by processing the sensor data and velocity data, representing velocity of the car mover within the hoistway lane, via a State Observe Filter; and the ACSA system controlling the car mover to avoid a collision between the elevator car and another object in response to estimating the operational state of the elevator car.

In addition to one or more of the above disclosed aspects of the method or as an alternate while traveling to a first landing at a first speed, and upon detecting a potential collision between the elevator car and another object, the ACSA system controls the car mover to: remain traveling to the first landing at the first speed; remain traveling to the first landing at a second speed that is reduced from the first speed; travel to a second landing that differs from the first landing or travel to a then determined stopping point; stop at a then current location.

In addition to one or more of the above disclosed aspects of the method or as an alternate, the method includes one or more of the sensor, a controller of the ACSA system, and a cloud service processing the sensor data and/or estimating the operational state of the elevator car.

In addition to one or more of the above disclosed aspects of the method or as an alternate, the method includes one or more of: the sensor communicating with a controller of the ACSA system directly, via a personal or local area network, or via a cloud service; and the car mover operating autonomously relative to an adjacent car mover that moves an adjacent elevator car in the hoistway lane.

In addition to one or more of the above disclosed aspects of the method or as an alternate, the method includes the ACSA system communicating with an adjacent car mover over a one or more transmission paths, including a wireless network via one or more of a personal area network, a local area network and a cloud service.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of elevator cars and car movers in a hoistway lane according to an embodiment;

FIG. 2 shows a car mover according to an embodiment;

FIG. 3 is a schematic of elevator cars and car movers in a hoistway lane showing additional features of the disclosed embodiments compared with FIG. 1;

FIG. 4 is a schematic of elevator cars and/or car movers equipped with primary and secondary communication devices;

FIG. 5 is a functional diagram of the State Observe Filter;

FIG. 6 is a block diagram of the elevator component separation assurance system illustrating a safety motion state estimator, a safety assurance module and a recovery manager; and

FIG. 7 is a flowchart showing a method of operating an elevator system according to an embodiment.

### DETAILED DESCRIPTION

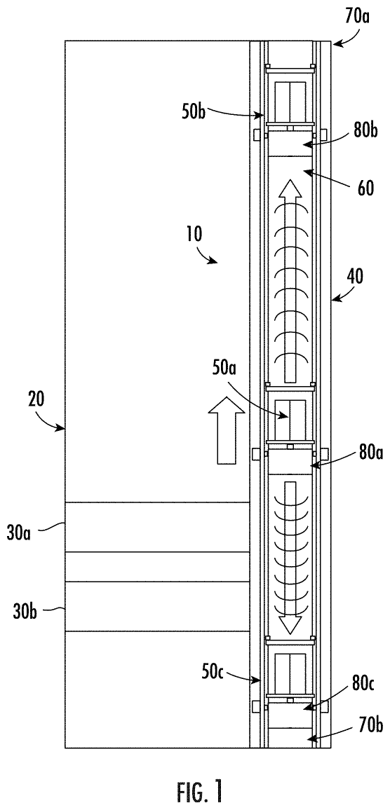

FIG. 1 depicts a self-propelled or ropeless elevator system (elevator system) 10 in an exemplary embodiment that may be used in a structure or building 20 having multiple levels or floors 30a, 30b. Elevator system 10 includes a hoistway 40 (or elevator shaft) defined by boundaries carried by the building 20, and a plurality of cars 50a-50c adapted to travel in a hoistway lane 60 in any number of travel directions (e.g., up and down). The cars 50a-50c are generally the same so that reference herein shall be to the elevator car 50a. The hoistway 40 may also include a top end terminus 70a and a bottom end terminus 70b.

For each of the cars 50a-50c, the elevator system 10 includes one of a plurality of car mover systems (car movers) 80a-80c (otherwise referred to as a beam climber system, or beam climber, for reasons explained below). The car movers 80a-80c are generally the same so that reference herein shall be to the car 50a. The car mover 80a is configured to move the elevator car 50a along the hoistway lane 60 and to operate autonomously.

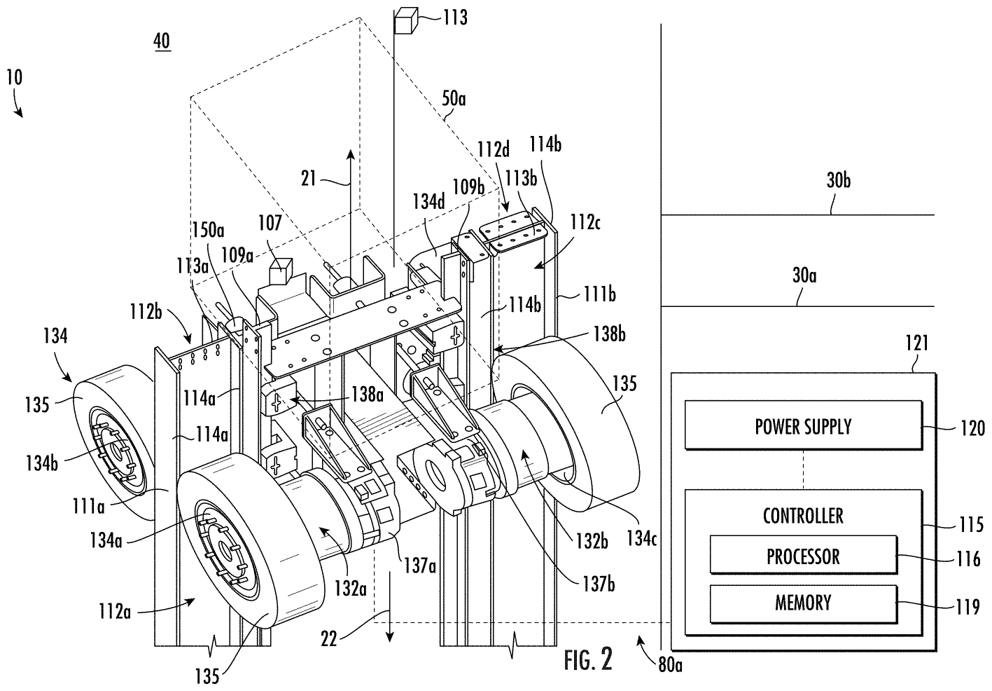

FIG. 2 is a perspective view of an elevator system 10 including the elevator car 50a, a car mover 80a, a controller 115, and a power source 120. Although illustrated in FIG. 1 as separate from the car mover 80a, the embodiments described herein may be applicable to a controller 115 included in the car mover 80a (i.e., moving through an hoistway 40 with the car mover 80a) and may also be applicable to a controller located off of the car mover 80a (i.e., remotely connected to the car mover 80a and stationary relative to the car mover 80a). Although illustrated in FIG. 1 as separate from the car mover 80a, the embodiments described herein may be applicable to a power source 120 included in the car mover 80a (i.e., moving through the hoistway 40 with the car mover 80a) and may also be applicable to a power source located off of the car mover 80a (i.e., remotely connected to the car mover 80a and stationary relative to the car mover 80a).

The car mover 80a is configured to move the elevator car 50a within the hoistway 40 and along guide rails 109a, 109b that extend vertically through the hoistway 40. In an embodiment, the guide rails 109a, 109b are T-beams. The car mover 80a includes one or more electric motors 132a, 132b. The electric motors 132a, 132b are configured to move the car mover 80a within the hoistway 40 by rotating one or more wheels 134a, 134b that are pressed against a guide beam 111a, 111b. In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d climb up 21 and down 22 the guide beams 111a, 111b. The guide beam extends vertically through the hoistway 40. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to car movers 80a having one or more electric motors. For example, the car mover 80a may have one electric motor for each of the four wheels 134a, 134b, 134c, 134d. The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 50a).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a.

The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 10 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the hoistway 40, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 50a.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b.

The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 10 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 50a.

The elevator system 10 may also include a positional reference system 113. The positional reference system 113 may be mounted on a fixed part at the top of the hoistway 40, such as on a support or guide rail 109, and may be configured to provide position signals related to a position of the elevator car 50a within the hoistway 40. In other embodiments, the positional reference system 113 may be directly mounted to a moving component of the elevator system (e.g., the elevator car 50a or the car mover 80a), or may be located in other positions and/or configurations.

The positional reference system 113 can be any device or mechanism for monitoring a position of an elevator car within the elevator shaft 117. For example, without limitation, the positional reference system 113 can be an encoder, sensor, accelerometer, altimeter, pressure sensor, range finder, or other system and can include positional sensing, including velocity sensing, acceleration sensing, absolute and relative position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 50a and the car mover 80a. For example, the controller 115 may provide drive signals to the car mover 80a to control the acceleration, deceleration, leveling, stopping, etc. of the elevator car 50a.

The controller 115 may also be configured to receive position signals from the positional reference system 113 or any other desired positional reference device.

When moving up 21 or down 22 within the hoistway 40 along the guide rails 109a, 109b, the elevator car 50a may stop at one or more floors 30a, 30b as controlled by the controller 115. In one embodiment, the controller 115 may be located remotely or in the cloud. In another embodiment, the controller 115 may be located on the car mover 80a

The power supply 120 for the elevator system 10 may be any power source, including a power grid and/or battery power which, in combination with other components, is supplied to the car mover 80a. In one embodiment, power source 120 may be located on the car mover 80a. In an embodiment, the power supply 120 is a battery that is included in the car mover 80a.

The elevator system 10 may also include an accelerometer 107 attached to the elevator car 50a or the car mover 80a. The accelerometer 107 is configured to detect an acceleration and/or a speed of the elevator car 50a and the car mover 80a.

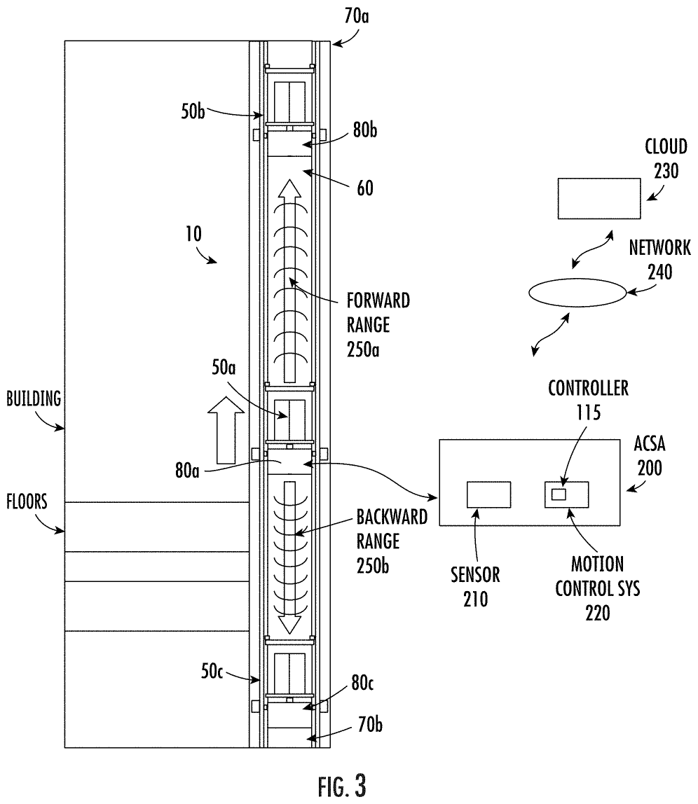

Turning to FIG. 3, additional features of the disclosed embodiment are shown. As indicated, the car mover 80a is configured to move the elevator car 50a along the hoistway lane 60 and to operate autonomously, e.g., of other car movers 80b, 80c for other elevator cars 50b, 50c in the hoistway 40.

The car mover 80a includes an Autonomous Car Separation Assurance (ACSA) system 200 that includes a sensor 210, which may include or be separate from the sensor 107 (FIG. 2), that is on-board the car mover 80a and configured to provide the ACSA system 200 with sensor data representing positional (including any and all of position, velocity and acceleration) information of the elevator car 50a. The ACSA system 200 may include a motion control system 220 configured to control motion of the car mover 80a. Alternatively, instructions (or sensor inputs) may be feed to the controller 115 that then controls car motion via the car mover 80a.

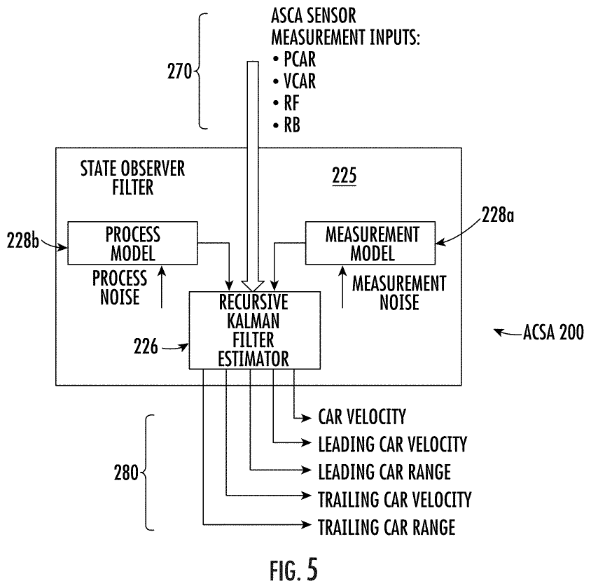

The ACSA system 200 may include software executable on one or more processors to estimate an operational state of the elevator car 50a by processing the sensor positional data, representing, for example, a velocity, acceleration and position of the car mover 80a within the hoistway 40, via a State Observe Filter 225 (FIG. 5). Additional details regarding the State Observe Filter 225 is provided below.

The ACSA system 200 is configured to control the car mover 80a to avoid a collision between the elevator car 50a and another object, such as another elevator car 50b, 50c or end terminus 70a, 70b, in response to estimating the operational state of the elevator car 50a. Such control may be to perform regular braking, or an emergency stop of the elevator car 50a, depending on breaking distance required and the likelihood of a collision occurring, e.g., relative to a threshold.

The motion control system 220 may include the controller 115 (FIG. 2), which may be onboard the car mover 80a, though the inclusion of another controller, that may be onboard or remotely located, for controlling the car mover 80a is within the scope of the disclosure. Thus the controller 115 may be operationally connected to the sensor 210 and configured to control movement of the car mover 80a. In one embodiment the controller 115 executes the estimating software referenced above. In one embodiment all processing is performed by the controller 115 alone or in combination with the sensor 210, so the elevator car and car mover combination are effectively autonomous and self-reliant.

According to an embodiment one or more of the sensor 210, the controller 115 and a cloud service 230 is configured to at least in part process the sensor data and/or estimate the operational state of the elevator car 50a. In an embodiment, the sensor 210 communicates with the controller 115 directly, via a wired connection or a wireless connection over a network 240, which may be personal or local area network, or via a cloud service 230.

The connection between each sensor and each gateway may be wireless or wired. Wireless connections may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same. Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub 1Ghz RF equipment operates in the ISM (industrial, scientific and medical) spectrum bands below Sub 1 Ghz—typically in the 769-935 MHz, 315 Mhz and the 468 Mhz frequency range. This spectrum band below 1Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems include cellular, e.g. 2G/3G/4G (etc.). The above is not intended on limiting the scope of applicable wireless technologies.

Wired connections may include, for example, cables/interfaces conforming to RS (recommended standard)-422, also known as the TIA/EIA-422, a technical standard supported by the Telecommunications Industry Association (TIA) and the Electronic Industries Alliance (EIA) that specifies electrical characteristics of a digital signaling circuit. Wired connections also include cables/interfaces conforming to RS-232, a technical standard for serial communication transmission of data, which defines signals connecting between a DTE (data terminal equipment) such as a computer terminal, and a DCE (data circuit-terminating equipment or data communication equipment), such as a modem. Wired connections may also include cables/interfaces conforming to the Modbus serial communications protocol, managed by the Modbus Organization, which is a master/slave protocol designed for use with programmable logic controllers (PLCs) and which is utilized to connect industrial electronic devices. Wired connections may also include cables/interfaces under the PROFibus (Process Field Bus) standard managed by PROFIBUS & PROFINET International (PI), and is a standard for fieldbus communication in automation technology, published as part of IEC (International Electrotechnical Commission) 61158. Wired communications may also include a Controller Area Network (CAN) bus, utilizing a CAN protocol released by the International Organization for Standards (ISO), which is a standard that allows microcontrollers and devices to exchange messages with each other in applications without a host computer. The above is not intended on limiting the scope of applicable wired technologies.

In one embodiment, the sensor 210 is configured for sensing one or more of elevator car position, velocity, a forward range 250a and a backward range 250b. In one embodiment, the sensor 210 includes one or more of a camera, radar, and LiDAR (Light Detection and Ranging) for sensing one or more of the forward range 250a and a backward range 250b. In one embodiment, all objects that the elevator car may physically contact, and which it should avoid, are equipped with a communications device configured to communicate over Bluetooth Low Energy or similar protocol. In such embodiment, a distance to the object may be determined based on a communications signal strength with the object.

The camera may include an RGB (Red-Green-Blue) camera with a wide/narrow view lens. In one embodiment, the sensor 210 is configured to sense one or more of the forward range 250a and a backward range 250b via ultrasonic distancing, laser distancing, magnetic detection, non-sacrificial physical compression/deflection detection, and sacrificial physical compression/deflection detection.

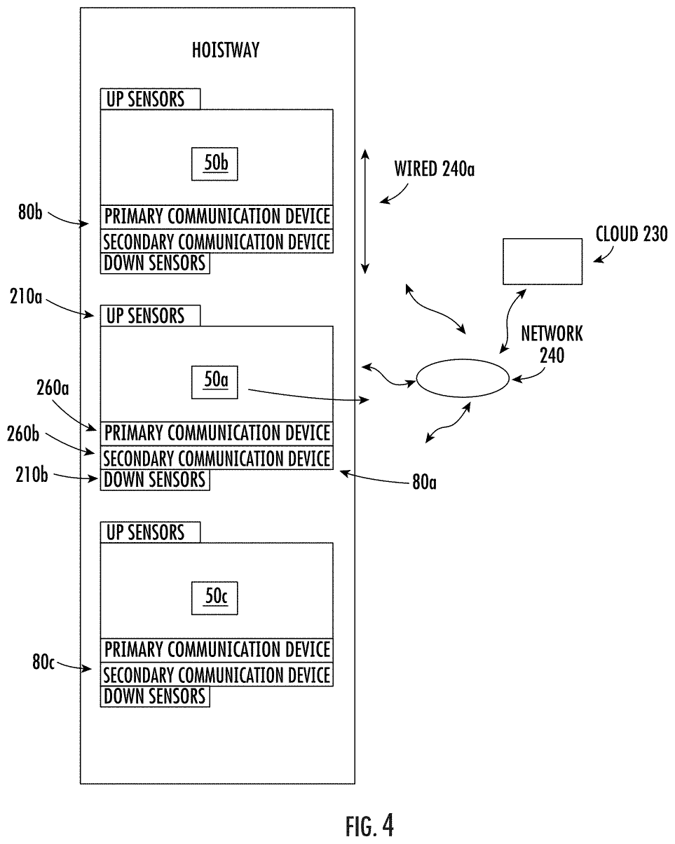

In one embodiment, rather than operating completely autonomously, control of the car mover 80a for collision avoidance may be at least in part based on communications between all car movers in a lane, e.g., as shown in FIG. 4 and discussed in greater detail below. In such a system, the operations shown in FIG. 4 may be utilized as a primary means to trigger a collision avoidance action. If such operations shown in FIG. 4 fail for any reason, the operations of FIG. 3 may function as a reliable backup to ensure separation avoidance.

In the embodiment of FIG. 4, the multiple sensors 210a, 210b (either one of which may be the sensor 210) are provided for each car movers 80a-80c and elevator cars 50a-50c. For example, where the car mover 80a is below the elevator car 50a, then an “up” sensor 210a may be on top of the elevator car 50a and a “down” sensor 210b may be located below the car mover 80a.

In one embodiment, the car mover 80a communicates with the other car movers 80b, 80c, e.g., via the a wired connection 240a, which may be any of the wired types of connection identified above, or the wireless network 240, which, as indicated above, may be a personal or local area network, or via a cloud service. As shown in FIG. 4, the car movers 80a-80c (or cars 50a-50c), may include both primary and secondary communication devices 260a, 260b, or transmission channels, so that a combination of wired and wireless protocols may be executed. In one embodiment one of the primary and secondary transmission channels 260a, 260b is on the car mover 80a and the other is on the elevator car 50a. Alternatively both the primary and secondary transmission channels 260a, 260b are mounted to the same one of the car mover 80a and the elevator car 50a.

The car mover 80a (or elevator car 50a) may send a signal to the other car movers 80b, 80c (or other cars 50b, 50c) when the likelihood of a collision is greater than a threshold limit. The signal may be an instruction (e.g., a command) to perform an emergency stop. The ACSA system 200 may also monitor for transmission from the adjacent car mover 80a to determine whether to move or stop moving based on receiving a similar signal from the other car mover 80a. The ACSA system 200 is configured to transmit periodic test signals (such as a ping) to the adjacent car mover 80a and monitor for periodic test signals transmitted from the adjacent car mover 80a to track transmission reliability.

In one embodiment, the primary transmission channel 260a is for broadcasting normal communications and the secondary transmission channel 260b is for broadcasting emergency communications. For example, the system may broadcast a normal stop command or status update to other cars in the hoistway through the primary transmission channel 260a, for example, via traveling communications cable in the hoistway, or wirelessly. The elevator system 10 may broadcast the emergency stop command to other cars 50b, 50c in the hoistway through the “emergency” secondary transmission channel 260b, e.g. wirelessly direct to the other cars 50b, 50c and/or car movers 80a, 80b, physically/electrically in the case of contact, etc. The emergency (secondary) transmission channel may be a different device than what is used for “normal” (primary) transmission channel.

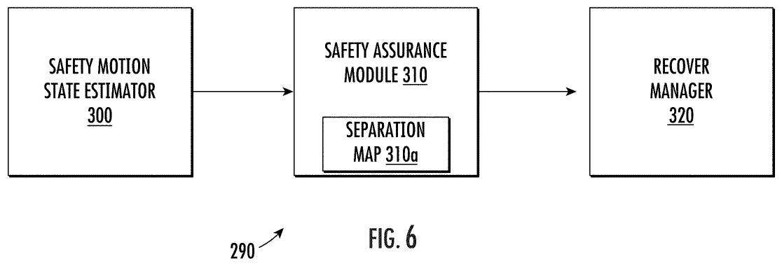

Turning to FIG. 5, additional features of the State Observe Filter 225 of the ACSA system 200 are shown. According to control theory, the State Observe Filter 225 may include a linear quadratic estimation (LQE), which in one embodiment is a Recursive Kalman Filter Estimator 226. This is an algorithm that uses a series of measurements observed over time, containing statistical noise and other inaccuracies, and produces estimates of unknown variables that tend to be more accurate than those based on a single measurement alone, by estimating a joint probability distribution over the variables for each timeframe. The State Observe Filter 225 in the disclosed embodiments includes a measurement model 228a and a process model 228b that may account for, and filter out, related information or data noise. The filter 225 receives inputs 270 such as sensor data, forward and backward range (Rf, Rb) to adjacent cars (or end terminus), velocity Vcar and position Pcar data. The Filter 225 utilizes the inputs 270 to obtain outputs 280 which are estimates if foundational inputs required for Safety Separation Assurance module 290 (FIG. 6, discussed below), including own car velocity, adjacent (leading and trailing) car velocity (which may be zero if it is an end terminus), and the range to the adjacent (leading and trailing) cars. The State Observe Filter 225 effectively filters out sensor noise and allows for a clean estimate of these critical states from on-board sensors on the car mover.

Outputs 280 from the State Observe Filter 225 may be fed into Safety Separation Assurance module 290, which includes switching and control logic disclosed in US20170088395 and US20090194371, the disclosure of each of which is incorporated by reference in its entirety.

For example, turning to FIG. 6, the Safety Separation Assurance module 290 of the ACSA system 200 may include the safety motion state estimator 300, a safety assurance module (SAM) 310 and a recovery manager 320. The safety motion state estimator 300, the SAM 310 and the recovery manager 320 may be substantially software-based and at least in-part programmed into the controller 115. The safety motion state estimator 300 may be configured to identify what elevator cars 50b, 50c are active (e.g., moving) around the car mover 80a and their positions relative to one-another in the elevator system 10.

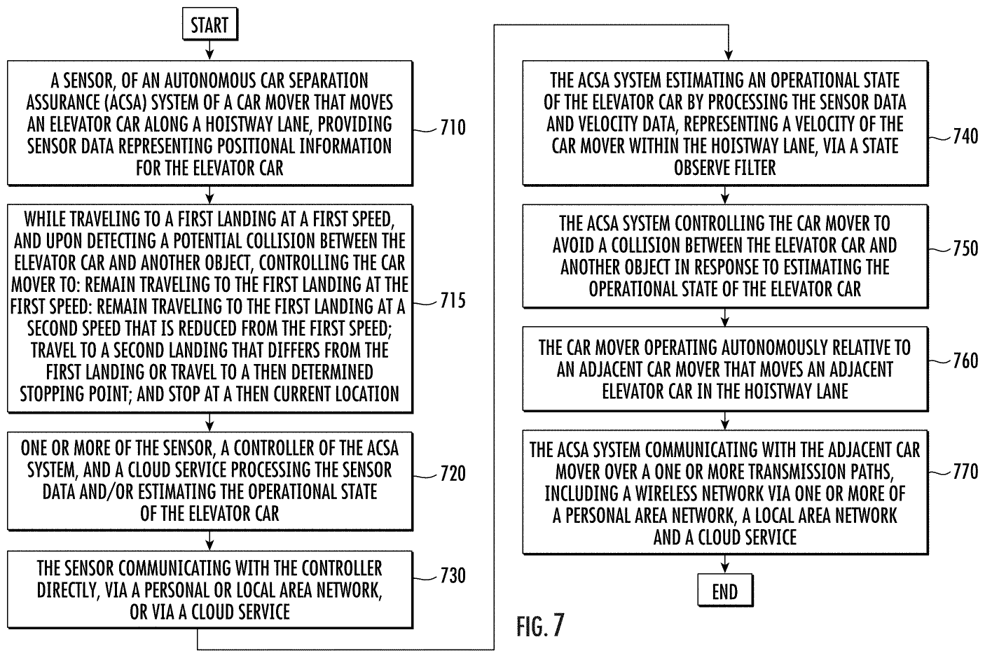

The SAM 310 is configured to make decisions about whether to drop the primary (normal) or secondary (emergency) brake based on sensory inputs (e.g., velocity, position and status) of objects (cars, hoistway terminus) and a pre-programmed separation map 310a generally based on the elevator system 10 physical layout. Additional operations by the SAM module 310 are identified below (see FIG. 7).

The recovery manager 320 is configured to detect and provide notification of a car separation assurance-induced event. The event may be actuation of a primary (normal) brake or actuation of the secondary (emergency) brake. A notification may be transmitted to the adjacent car 50b, 50c (or all cars in the system) and serve to temporarily reduce car speeds to minimize any potential for insufficient separation of all cars from one-another. If multiple safety actions are detected, the recovery manager 320 may be configured to instruct all elevator cars 50a-50b to stop at the nearest reachable floor 30a, 30b (FIG. 1). It is further contemplated and understood that the recovery manager 320 may be configured to confirm when it is “safe to run” following a separation assurance-induced event. It is further contemplated and understood that the car separation assurance-induced event may be other than a normal or emergency stop. It is further understood that the reaction to the event(s) by the recovery manager 320 may include other actions and/or a different number of events must take place for certain actions to be initiated.

Turning to FIG. 7, a flowchart shows a method of operation the elevator system 10. As shown in block 710, the method includes a sensor 210, of an Autonomous Car Separation Assurance (ACSA) system 200 of a car mover 80a that moves an elevator car 50a along a hoistway lane 60, providing sensor data representing positional information for the elevator car 50a.

As shown in block 715, while traveling to a first landing at a first speed, and upon detecting a potential collision between the elevator car 50a and another object, the method includes ACSA system 200 controlling the car mover 80a to: remain traveling to the first landing at the first speed: remain traveling to the first landing at a second speed that is reduced from the first speed; travel to a second landing that differs from the first landing or travel to a then determined stopping point; and stop at a then current location. The stopping may occur using elevator safety brakes or primary brakes, depending on the stopping requirements. These options may be controlled via the SAM module 310.

As shown in block 720, the method includes one or more of the sensor 210, a controller 115 of the ACSA system 200, and a cloud service 230 processing the sensor data and/or estimating the operational state of the elevator car 50a.

As indicated, in one embodiment all processing is performed by the controller 115 alone or in combination with the sensor 210, so the elevator car and car mover combination are effectively autonomous and self-reliant. However, in one embodiment, as shown in block 730, the method includes the sensor 210 communicating with the controller 115 directly, via wireless network 240 that may be a personal or local area network, or via a cloud service 230. As shown in block 740, the method includes the ACSA system estimating an operational state of the elevator car 50a by processing the sensor data and velocity data, representing a velocity of the car mover 80a within the hoistway lane 60, via a State Observe Filter 225.

As shown in block 750, the method includes the ACSA system 200 controlling the car mover 80a to avoid a collision between the elevator car 50a and another object (e.g., an adjacent elevator car 50b, 50c or end terminus 70a, 70b) in response to estimating the operational state of the elevator car 50a. As shown in block 760, the method includes the car mover 80a operating autonomously relative to an adjacent car mover 80b, 80c that moves an adjacent elevator car 50b, 50c in the hoistway lane 60. As shown in block 770, the method includes the ACSA system 200 communicating with the adjacent car mover 80b, 80c over a one or more transmission paths, including a wireless network 240 via one or more of a personal area network, a local area network and a cloud service.

Thus, the car mover elevator system allows for multiple cars to be operational in a single hoistway (lane) and, in some utilizations, with horizontal transfer stations (not shown) in a set of up and down lanes (not shown) in a recirculation configuration. It differs from other Multi-Car Ropeless (MCRL) systems in that the car mover 80a includes a control system that is on the car mover 80a, or elevator car 50a, rather than in the hoistway/lane. In this sense the car mover 80a is an autonomous vehicle that has an on-board collision avoidance system (otherwise referred to as a “separation assurance” system), rather than a lane control system that accesses the motion state data from the multiple cars. In addition, the intercommunication capabilities between the adjacent cars and/or movers, identified above enable a last resort “safety chain” style collision avoidance. This system may put the car in a “stopped” operation mode if any of the devices detect an unsafe situation.

Benefits of the disclosed embodiments include effectively measuring and estimating key motion states using on-board sensors and a State Observe Filter for the autonomous vehicle and neighboring vehicles velocities and ranges. This can then be fed into the Safety Separation Assurance system to avoid collisions in multi-car elevator systems. In addition, the absolute position of a specific car or any of the cars in a hoistway are not needed since absolute position may not necessarily be known by a car itself, or other cars in the proximity (e.g., communication with the hoistway control/dispatcher failure, etc., is no longer necessary). The benefits further include providing a system and method for one car to stop other cars in the hoistway, which effectively provides redundant sets of sensors for collision avoidance. Having a secondary method for cars to communicate directly with each other further reduces a probability of car collision.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A ropeless elevator system comprising:
a car mover operationally connected to an elevator car, the car mover configured to move the elevator car along a hoistway lane and to operate autonomously,
wherein the car mover includes an Autonomous Car Separation Assurance (ACSA) system that includes:
a sensor configured to provide sensor data representing positional information of the elevator car,
a motion control system configured to control motion of the car mover,
wherein the ACSA system is configured to estimate an operational state of the elevator car by processing the sensor data and velocity data, representing velocity of the car mover within the hoistway lane, via a State Observe Filter, and
wherein the ACSA system is configured to control the car mover to avoid a collision between the elevator car and another object in response to estimating the operational state of the elevator car.

2. The system of claim 1, wherein:
the ACSA system includes a controller that controls the car mover, the controller operationally connected to the sensor and configured to control movement of the car mover,
wherein one or more of the sensor, the controller and a cloud service is configured to at least in part process the sensor data and/or estimate the operational state of the elevator car.

3. The system of claim 1, wherein:
the sensor communicates with a controller of the ACSA system directly, via a personal or local area network, or via a cloud service.

4. The system of claim 1, wherein:
the ACSA system is configured to control the car mover to avoid a collision between the elevator car and a hoistway terminus in response to estimating the operational state of the elevator car.

5. The system of claim 1, wherein:
the ACSA system is configured to control the car mover and/or the elevator car to execute an emergency stop in response to estimating the operational state of the elevator car.

6. The system of claim 1, wherein:
the State Observe Filter includes a Recursive Kalman Filter Estimator.

7. The system of claim 1, wherein:
the sensor is configured for sensing one or more of elevator car position, velocity, a forward range and a backward range.

8. The system of claim 1, wherein:
the sensor includes one or more of a camera, radar, and LiDAR for sensing one or more of a forward range and a backward range.

9. The system of claim 1, wherein:
the sensor is configured to sense one or more of a forward range and a backward range via ultrasonic distancing, laser distancing, magnetic detection, non-sacrificial physical compression/deflection detection, and sacrificial physical compression/deflection detection.

10. The system of claim 1, wherein:
the ropeless elevator system is a multi-car ropeless system, and the car mover is configured to operate autonomously relative to an adjacent car mover that moves an adjacent elevator car in the hoistway lane.

11. The system of claim 1, wherein:
the ACSA system is configured to control the elevator car to avoid a collision between the elevator car and an adjacent elevator car moving in the hoistway lane in response to estimating the operational state of the elevator car.

12. The system of claim 1, wherein:
the ACSA system is configured to transmit a signal to an adjacent car or adjacent car mover in the hoistway lane, via one or more transmission paths, upon determining a likelihood of a collision is above a threshold.

13. The system of claim 12, wherein:
the ACSA system is configured to transmit a stop command as the signal to the adjacent car or adjacent car mover in the hoistway lane, via the one or more transmission paths, upon determining the likelihood of the collision is above the threshold.

14. The system of claim 10, wherein:
the ACSA system is configured to communicate with the adjacent car mover over a wireless connection via one or more of a personal area network, a local area network and a cloud service.

15. The system of claim 10, wherein:
the ACSA system is configured to transmit periodic test signals to the adjacent car mover and monitor for periodic test signals transmitted from the adjacent car mover to track transmission reliability.

16. A method of operating a ropeless elevator system, comprising:
a sensor, of an Autonomous Car Separation Assurance (ACSA) system of a car mover that moves an elevator car along a hoistway lane, providing sensor data representing positional information for the elevator car;
the ACSA system estimating an operational state of the elevator car by processing the sensor data and velocity data, representing velocity of the car mover within the hoistway lane, via a State Observe Filter; and
the ACSA system controlling the car mover to avoid a collision between the elevator car and another object in response to estimating the operational state of the elevator car.

17. The method of claim 1, wherein:
while traveling to a first landing at a first speed, and upon detecting a potential collision between the elevator car and another object, the ACSA system controls the car mover to:
remain traveling to the first landing at the first speed;
remain traveling to the first landing at a second speed that is reduced from the first speed;
travel to a second landing that differs from the first landing or travel to a then determined stopping point;
stop at a then current location.

18. The method of claim 16, comprising:
one or more of the sensor, a controller of the ACSA system, and a cloud service processing the sensor data and/or estimating the operational state of the elevator car.

19. The method of claim 16, comprising one or more of:
the sensor communicating with a controller of the ACSA system directly, via a personal or local area network, or via a cloud service; and
the car mover operating autonomously relative to an adjacent car mover that moves an adjacent elevator car in the hoistway lane.

20. The method of claim 16, comprising:
the ACSA system communicating with an adjacent car mover over a one or more transmission paths, including a wireless network via one or more of a personal area network, a local area network and a cloud service.
